(19) United States
(12) Patent Application Publication
(10) Pub. No.: US 2025/0083455 A1
(43) Pub. Date: Mar. 13, 2025

(54) METHOD OF COMPENSATING FOR A FAILED PRINT NOZZLE OF AN INKJET PRINTHEAD

(71) Applicants: Heidelberger Druckmaschinen AG, Heidelberg (DE); Gallus Ferd. Rueesch AG, St. Gallen (CH)

(72) Inventors: Clarissa Benzin, Heidelberg (DE); Annika Kamper, Dossenheim (DE); Emilia Göb, Heidelberg (DE); Johann Weigert, Ubstadt-Weiher (DE); Hans Köhler, Edingen-Neckarhausen (DE)

(21) Appl. No.: 18/883,036

(22) Filed: Sep. 12, 2024

(30) Foreign Application Priority Data
Sep. 12, 2023 (DE) 10 2023 124 582.1

(51) Int. Cl. B41J 2/21

(52) U.S. Cl. CPC B41J 2/2139; B41J 2/2142

(57) ABSTRACT

A method for compensation for a failed print nozzle of an inkjet printhead for the printing of a printed image onto a print material conveyed in a transport direction, includes printing the printed image with at least two different print droplet volumes, one of which is a maximum print droplet volume. At least one compensation nozzle, i.e. a neighboring nozzle of the failed nozzle, prints compensation droplets with an elevated compensation droplet volume compared to the maximum print droplet volume. A frequency for the creation of compensation droplets is defined, and the compensation nozzle is actuated such that the defined frequency is observed and the successive compensation droplets printed by the compensation nozzle have a defined minimum separation in the transport direction.

### CROSS-REFERENCE TO RELATED APPLICATION

This application claims the priority, under 35 U.S.C. § 119, of German Patent Application DE 10 2023 124 582.1, filed Sep. 12, 2023; the prior application is herewith incorporated by reference in its entirety.

### FIELD AND BACKGROUND OF THE INVENTION

The invention relates to a method of compensating for a failed print nozzle of an inkjet printhead for the printing of a printed image onto a print material conveyed in a transport direction, in which the printed image is printed with at least two different print droplet volumes, one of which is a maximum print droplet volume, and at least one compensation nozzle, i.e. a neighboring nozzle of the failed nozzle, prints compensation droplets with an elevated compensation droplet volume compared to the maximum print droplet volume.

The invention is in the technical field of the graphics industry, and in particular in the sector of industrial, i.e. high-productivity, inkjet printing onto flat substrates, i.e. image-wise application of ultrafine droplets of liquid ink—expelled from nozzles—onto print materials in the form of sheets, rolls, foils or labels, preferably of paper, cardboard, paperboard, plastic, metal or composite material, with compensation for non-expelling or incorrectly expelling nozzles, for example by their neighboring nozzles, and avoidance of print defects in that manner.

### DESCRIPTION OF THE RELATED

An inkjet printhead generally has a multiplicity of individually actuatable nozzles. The nozzles are generally disposed in one row of nozzles or multiple rows of nozzles, parallel (or slightly inclined) relative to the transport direction of the print material. Each nozzle, when actuated, creates one or more ink droplets. If a nozzle is permanently actuated, it prints a visible line in the ink color on the print material. On the other hand, a likewise visible white line (also referred to as “missing nozzle” or “missing line”) may be formed if a nozzle fails, for example because the nozzle opening thereof is blocked with solidified ink, or if a nozzle expels the droplets obliquely or merely as mist. An unwanted result is that the print material color, usually white, appears as a line in the printed image. In addition, there can also be visible dark lines, for example in the case of overcompensated faulty nozzles.

Such nonprinting or incorrectly printing nozzles must be compensated for in the industrial sector since white lines in high-quality print products are not tolerated by the customer. A known method uses the propensity of printhead nozzles, depending on their actuation, to create droplets of different size. In that way, neighboring nozzles (to the “right and left” of the defective nozzle) can be used to create larger compensation droplets, i.e. those with more ink volume, and to use the excess ink thereof to wholly close the white line, or at least in such a way that it is no longer perceived as defective by the naked eye.

The abbreviation MNC used in this field stands for “missing nozzle compensation” or more generally “malfunctioning nozzle compensation,” i.e. for compensation of nonprinting or incorrectly printing print nozzles.

An already known method of identifying those nonprinting or incorrectly printing nozzles or the respective position thereof in the row of nozzles is to print a test pattern configured for that purpose and to record it, for example by using a camera, and evaluate the recorded image by using a computer. It is possible in that case to determine a compensation intensity for a nozzle recognized as requiring compensation, which fixes the degree of compensation, for example low or high compensation.

German Patent Application DE 10 2015 220 716A1 discloses a method for automatically compensating for failed printing nozzles in inkjet printing systems by using a control computer, the method including the following steps: printing a test form for a specific material combination; evaluating the print of the test form and creating a look-up table including compensation probabilities from 0 to 1 as a function of local surface density; detecting a failed printing nozzle; reading, from printing data, a size of an intended droplet to be compensated for at a location of the failed printing nozzle; calculating a local surface density at the location of the failed printing nozzle; reading a compensation probability from the look-up table with the calculated local surface density; calculating a pseudo-random number between 0 and 1 for a respectively adjacent pixel on the right and left of the pixel to be compensated for; increasing the droplet size for the adjacent pixels on the right and left of the pixel to be compensated for if the respectively associated pseudo-random number for this pixel is lower than the compensation probability read from the look-up table; calculating adjacent droplet sizes for all intended droplets to be compensated for at the location of the failed printing nozzle and using the changed droplet sizes in the printing data; and carrying out a print job with the changed printing data.

German Patent Application DE 10 2018 201 674A1 discloses a method for carrying out a printing operation on an inkjet printing machine while compensating for failed printing nozzles by using a computer using a corrective halftone image, wherein, after the screening process which creates a halftone image for an image to be printed, failed printing nozzles are compensated for by increased ink application from adjacent printing nozzles, and which has the feature of precalculating at least one corrective halftone image for the adjacent printing nozzles by using the computer, which replaces the halftone image created in the screening process in the at least one column of the adjacent printing nozzles; and the printing operation is carried out on the inkjet printing machine using that corrected halftone image.

In the determination of a maximum printable tone value (within the scope of enlargement of the achievable color space), it should be ensured that the tone value is compensatable in the event of possible failure of nozzles and that, in the case of compensation, the compensating nozzle will not likewise fail through overloading by the generally higher ink volume for the compensation.

### SUMMARY OF THE INVENTION

It is accordingly an object of the invention to provide an improved method of compensating for a failed print nozzle of an inkjet printhead, which overcomes the hereinafore-mentioned disadvantages of the heretofore-known methods of this general type and which makes it possible in particular to further improve compensation for failed or incorrectly printing nozzles and hence a further increase in print quality, especially in the event of an increase in the achievable color space.

With the foregoing and other objects in view there is provided, in accordance with the invention, a method of compensation for a failed print nozzle of an inkjet printhead for the printing of a printed image onto a print material conveyed in a transport direction, in which the printed image is printed with at least two different print droplet volumes, one of which is a maximum print droplet volume, at least one compensation nozzle, i.e. a neighboring nozzle of the failed nozzle, prints compensation droplets with an elevated compensation droplet volume compared to the maximum print droplet volume, a frequency for the creation of compensation droplets is defined, and the compensation nozzle is actuated in such a way that the defined frequency is observed and the successive compensation droplets printed by the compensation nozzle have a defined minimum separation in transport direction.

Advantageous and therefore preferred developments of the invention will be apparent from the dependent claims and from the description and drawings.

### ADVANTAGEOUS CONFIGURATIONS AND EFFECTS OF THE INVENTION

The invention advantageously makes it possible to further improve compensation for failed or incorrectly printing nozzles and hence to further increase print quality, especially in the case of an increase in the achievable color space.

According to the invention, it is possible to increase the color space, to effectively compensate for possible print defects as a result of nonprinting or incorrectly printing print nozzles, and simultaneously to ensure that the compensation nozzles are not permanently overloaded and fail themselves.

The meaning of the phrase “wherein the printed image is printed with at least two different print droplet volumes” is that, for example, in the printing of the printed image, small(S), medium (M) and large (L) droplets are used, where the printed ink volumes may be in the region of 2, 4 and 6 picoliters.

The meaning of the phrase “one of which is a maximum print droplet volume” is, for example, that the large-volume L droplet is the largest ink droplet used in the printing operation.

The meaning of the phrase “where at least one compensation nozzle prints compensation droplets with an elevated compensation droplet volume compared to the maximum print droplet volume” is, for example, that the compensation droplets are larger than the L droplets, i.e., for example, have a droplet volume of more than about 6 picoliters.

The meaning of the phrase “that a frequency for the creation of compensation droplets is defined” is, for example, that the value of the frequency is recorded digitally in a control device for the printheads or the compensation process.

The meaning of the phrase “that the compensation nozzle is actuated in such a way that the defined frequency is observed” is that, for example, a compensation nozzle (to the left or right of the failed or defective nozzle) sets compensation droplets in transport direction with a frequency corresponding to the defined frequency.

The meaning of the phrase “and the successive compensation droplets printed by the compensation nozzle have a defined minimum separation in transport direction” is, for example, that, in the case of a defined frequency of 50%, every second possible compensation droplet is set, in the case of a defined frequency of 33% every third possible compensation droplet, and in the case of a defined frequency of 25% every fourth possible compensation droplet. The compensation droplets are consequently printed regularly, i.e. with the same respective separation and in particular without stochastic distribution. This also improves the ink flow character, in such a way that the troublesome white line is better closed.

According to the invention, compensation pixels are set in print direction with observation of a defined frequency, and this frequency is supplemented by the requirement for a minimum separation to be observed between the compensation pixels to be set. An example: if the frequency is set at 50%, exactly every second pixel is printed with the compensation droplet, in such a way that the minimum separation between the compensation pixels is permanently a single pixel.

An additional further requirement may advantageously be that—in the case that the nozzle to be compensated for does not set a pixel at the site to be compensated for locally in the image—there is nevertheless local compensation by the neighboring nozzles. Conversely, this means that the setting of the compensation pixels according to the frequency is not in accordance with the pattern used (which is prior art); where there are pixels in the printed image and they are typically set microscopically in a structure by the pattern, the larger compensation droplets are also set instead. It is also the case that the frequency of setting of the compensation pixels is not controlled with a random algorithm (which is also prior art); instead, the aim is the smallest possible separation between compensation pixels in print direction. The result may accordingly be larger or smaller separations in some cases between the compensation pixels.

The invention accordingly enables the following: the darkest tone value to be compensated for can be selected so as to be darker than in the prior art, and the color space of the inkjet printing machine can be increased.

According to the invention, larger droplets than according to the specification of the inkjet printhead can be printed when the droplets maintain a certain distance from one another, so as not to exceed the maximum amount of ink defined by the specification per unit time per nozzle.

### DEVELOPMENT OF THE INVENTION

There follows a description of preferred developments of the invention (developments for short).

One development may have the feature that print droplet volumes that may be printed permanently are defined for the printhead, and that the compensation droplets are printed with an elevated compensation droplet volume compared to the permanent droplet volume. The permanent droplet volumes are generally defined within the scope of the specification of the printhead. This limitation of the printhead on the part of the manufacturer is advantageously exceeded briefly for a small number of droplets with the droplet compensation volume, but in such a way as to rule out damage to the printhead. It is accordingly possible to choose a volume for the compensation droplets which is above the actually permitted specification for the amount of ink (i.e. if this amount were to be set permanently), and it is possible to set, for example, every second (or third or fourth etc.) pixel with such a compensation droplet. This can make it possible to apply a greater amount of ink in any region and to cover the incorrectly ink-free area of the printed image transverse to print direction with (compensation) ink droplets and hence to eliminate the fault.

One development may have the feature that the method is used over and above a tone value at which at least 90% or at least 95% of the pixels required for the printed image are set.

One development may have the feature that the method is used over and above a tone value of at least 50% or at least 55% or at least 65%.

One development may have the feature that the frequency H is defined as a percentage where H=P/Pmax and where P is the number of compensation droplets to be set and Pmax is the number of maximum settable compensation droplets, in each case in transport direction.

The features and combinations of features disclosed in the above sections “Field and Background of the Invention,” “Summary of the Invention,” Advantageous Configurations and Effects” and “Development of the Invention,” and in the “Detailed Description of the Invention” section below, in any combination with one another, constitute further advantageous developments of the invention.

Other features which are considered as characteristic for the invention are set forth in the appended claims.

Although the invention is illustrated and described herein as embodied in a method of compensating for a failed print nozzle of an inkjet printhead, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1 and 2 are diagrammatic views of apparatuses shown in the performance of a preferred working example of a method of the invention.

### DETAILED DESCRIPTION OF THE INVENTION

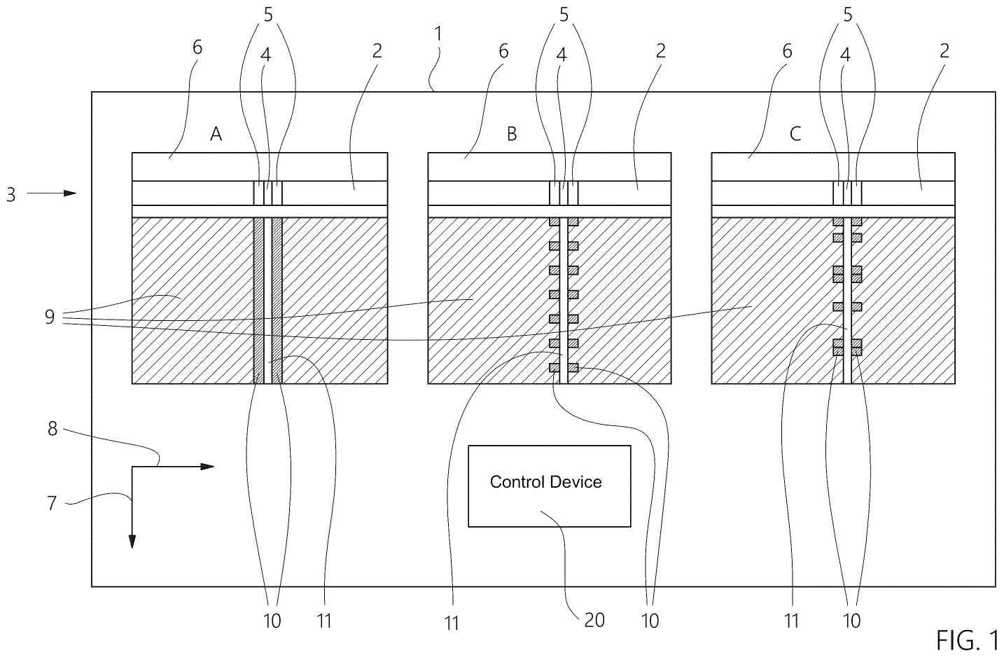

Referring now in detail to the figures of the drawings, in which mutually corresponding features are given the same reference numerals, and first, particularly, to FIG. 1 thereof, there are seen three examples A, B and C, one alongside another, for compensation of a white line, where example B in the middle corresponds to the present invention.

A printing machine 1 is shown for inkjet printing with multiple printheads 2, which are preferably disposed alongside one another as a print bar (preferably for the printing of ink of one color, e.g. C, M, Y or K). Each printhead 2 has a multiplicity of print nozzles 3 (only three print nozzles 3 are shown by way of example in each case). The middle of the three print nozzles 3 shown is a nozzle 4 that has been switched off for testing purposes, and thus simulates a failed or defective nozzle. The two adjacent nozzles 5 to the left and right of that nozzle and the white line 11 formed serve as compensation nozzles 5.

The printing machine 1 prints a print material 6 being conveyed in a transport direction 7. The printheads 2, in the print bar, are disposed alongside one another in transverse direction 8 and print the ink droplets preferably from above onto the print material 6 being moved through beneath the printheads 2. This creates a printed image 9 or at least a print control element 9 on the print material 6. For testing purposes, the printed image/print control element 9 may correspond as shown (by the crosshatch) to a full-tone image or element.

In order to control the printing operation and especially the compensation, the printing machine 1 includes a control device 20.

The following assumptions are made for all examples A, B and C: the tone value of the image 9 or element 9 is formed of 100% set pixels; the nozzle 4 to be compensated for is in each case switched off for test purposes (i.e. it does not print, and the white line 11 is formed); the neighboring pixels 10 are set by the neighboring nozzles 5 of the switched-off nozzle 4 transverse to the transport direction 7 in such a way that they fundamentally print with droplets having a greater volume than the pixels in the regular 100% tone value.

A (according to the prior art): all compensation pixels 10 are set to the left and right of the switched-off nozzle 4. The droplet volume of the compensation pixels 10 is within the head specification, and each pixel is allowed to be set with that volume.

B (the method of the invention): the compensation pixels 10 are set to the left and right of the switched-off nozzle 4 according to a defined frequency, keeping the separation between the pixels 10 to a minimum. The droplet volume of the compensation pixels 10 is outside the head specification, and it is permitted to set a maximum defined frequency of <100% of pixels with that volume. In the example shown, the frequency is 33%, and this means that every third pixel 10 is set for compensation to the left and right of the white line 11.

C (according to further prior art): the compensation pixels 10 are set to the left and right of the switched-off nozzle 4 according to a frequency, where the setting is implemented stochastically according to the frequency and the separation between the compensation pixels 10 varies stochastically. The droplet volume of the compensation pixels 10 is outside the head specification; it is permitted to set a maximum defined frequency of <100% of pixels 10 with that volume. In the example shown, the frequency is likewise 33%.

The two (compensation) ink volumes applied in case B and in case C are equal—viewed over the distance of compensation in the transport direction 7.

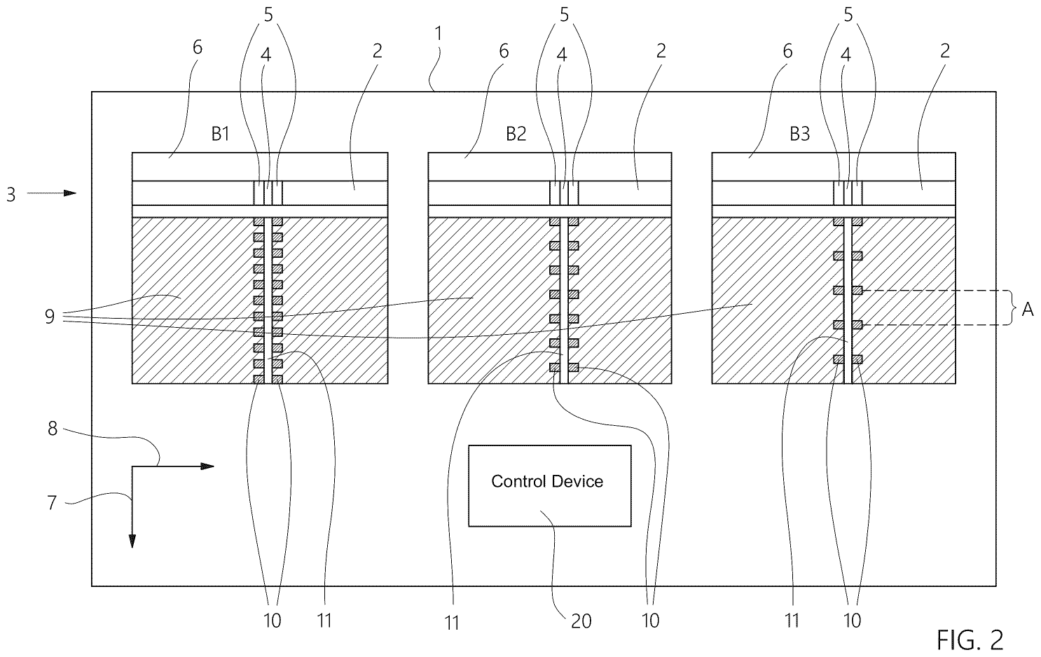

FIG. 2 shows three inventive examples B1, B2 and B3 alongside one another for compensation of a white line 11.

The three examples do not fundamentally differ from one another. However, a different frequency was defined in each example: in example B1 a frequency of 50% (every second pixel is set), in example B2 a frequency of 33% (every third pixel is set), and in example B3 a frequency of 25% (every fourth pixel is set). It is apparent that the successive compensation droplets 10 printed by the compensation nozzle 5 have only a minimum separation A in transport direction (shown by way of example only in case B3). None of the droplets 10 or corresponding pixels 10 has a greater separation (from its “neighboring” compensation droplets positioned upstream and downstream in transport direction) than the minimum separation A.

The following is a summary list of reference numerals, and the corresponding structure used in the above description of the invention:
1 printing machine
2 printhead, print bar
3 nozzle(s)
4 failed or defective nozzle(s)
5 compensation nozzle(s), neighboring nozzle(s)
6 print material
7 transport direction
8 transverse direction
9 printed image, especially printed test image, or print control element
10 compensation pixels or droplets (on the print material)
11 white line
20 control device
A separation

1. A method of compensating for a failed print nozzle of an inkjet printhead for printing a printed image onto a print material conveyed in a transport direction, the method comprising:
printing the printed image with at least two different print droplet volumes, one of the print droplet volumes being a maximum print droplet volume, and at least one compensation nozzle printing compensation droplets with an elevated compensation droplet volume compared to the maximum print droplet volume;
defining a frequency for creation of compensation droplets, and actuating the at least one compensation nozzle to observe the defined frequency and to provide successive compensation droplets printed by the at least one compensation nozzle with a defined minimum separation in the transport direction.

2. The method according to claim 1, which further comprises providing the at least one compensation nozzle as a neighboring nozzle of the failed nozzle.

3. The method according to claim 1, which further comprises defining print droplet volumes that may be printed permanently for the printhead, and printing the compensation droplets with an elevated compensation droplet volume compared to the permanently printed droplet volume.

4. The method according to claim 1, which further comprises performing the method over and above a tone value at which at least 90% of pixels required for the printed image are set.

5. The method according to claim 1, which further comprises performing the method over and above a tone value at which at least 95% of pixels required for the printed image are set.

6. The method according to claim 1, which further comprises performing the method over and above a tone value of at least 50%.

7. The method according to claim 1, which further comprises performing the method over and above a tone value of at least 55%.

8. The method according to claim 1, which further comprises performing the method over and above a tone value of at least 65%.

9. The method according to claim 1, which further comprises defining the frequency H as a percentage where:
H=P/Pmax,
P is a number of compensation droplets to be set, and
Pmax is a number of maximum settable compensation droplets;
in the transport direction.
